(19) United States
(12) Patent Application Publication
(10) Pub. No.: US 2006/0042438 A1
(43) Pub. Date: Mar. 2, 2006

(54) Modular support stand for workpieces in miter saw operations

(76) Inventor: Jason Poelman, Boulder Creek, CA (US)

Correspondence Address: CENTRAL COAST PATENT AGENCY, PO BOX 187, AROMAS, CA, 95004, US

(21) Appl. No.: 10/932,984

(22) Filed: Sep. 1, 2004

(51) Int. Cl. B26D 7/06

(52) U.S. Cl. 83/84

(57) ABSTRACT

A two-part roller support stand has a vertically-adjustable base portion having a plural-point support structure for standing on a ground or floor plane, and a first upper engagement interface, a separate and detachable roller assembly having a roller, a second engagement interface for engaging the first engagement interface, and a plurality of first vertically adjustable feet. The separate roller assembly may be disengaged from the base portion and used, supported on its plurality of adjustable feet, as a stand-alone roller support on such as a table-top or other surface. Additional used for the stand are taught as well

### FIELD OF THE INVENTION

The present invention is in the field of support apparatus for use by finish carpenters, and pertains more particularly to stands for supporting workpieces during operations with powered miter saws.

### BACKGROUND OF THE INVENTION

It is well-known in the woodworking arts that finish carpenters, particularly in home construction, work extensively with miter saws, such as V compound saws, which are also known in the art as chop saws. These are power saws with a rotary saw mechanism mounted on a translatable carriage above a support table, with further mechanisms allowing the saw to be rotated in two to four degrees. These saws are used in every phase of construction, from rough framing to trim moldings, such as baseboard and crown moldings, with angled ends to fit together in inside and outside corners. There are other uses as well.

Chop saws have a relatively small table surface upon which a length of molding or other material may be placed, typically against a guide called a fence, to be trimmed. Typical moldings, however may be longer than the table, in many cases many times longer than the table. In some cases of new home construction it is not unusual for baseboard molding to be in excess of thirty feet long.

In operation a chop saw is typically set up on a surface, such as a piece of plywood, on a pair of sawhorses, so the table of the chop saw is at a convenient height for the carpenter. Consider an example with a chop saw having a table 18 inches wide, set up on a surface 48 inches wide. If a piece of molding to be cut is at most a few inches longer than one-half the width of the chop saw table, that piece may be relatively easily and safely held against the fence on the table of the chop saw. If the piece to be cut is, for example two to three feet long, it will need to be supported above the surface of the plywood or other plane surface upon which the chop saw is placed. Most finish carpenters do this by tacking a wooden support to the plywood surface near the chop saw. If a piece is much longer than three feet, then for safe a sure operation the piece has to be supported by a stand of some sort on the ground at some distance from the chop saw. Further, for very long pieces more than one support will be needed.

There are adjustable roller support stands in the art that stand on the floor (inside) or on the ground (outside), having a relatively wide roller at the top, for placing away from a supported chop saw to support relatively long pieces to be cut. For closer support for shorter pieces, however, a lot of time is taken by carpenters to fabricate makeshift support on the surface supporting the chop saw, to support shorter pieces to be cut.

What is clearly needed is an adjustable, roller support stand with a removable upper roller assembly, such that the unit may be used as support for long pieces, and the upper roller assembly may be removed from the support stand to provide a roller stand for support on the surface holding the chop saw, for shorter pieces of material.

### SUMMARY OF THE INVENTION

In an embodiment of the invention a two-part support stand is provided, comprising a vertically-adjustable base portion having a multiple-point support structure for standing on a ground or floor plane, and a first upper engagement interface, and a separate and detachable assembly having an upper carrier element, a second engagement interface for engaging the first engagement interface, and a plurality of first vertically adjustable feet. The separate detachable assembly, attached to the base portion may be used to support workpieces on the vertically-adjustable base portion, or may be disengaged from the base portion and used, supported on its plurality of adjustable feet, as a stand-alone support for workpieces.

In one embodiment the plural-point support structure comprises one or more second vertically-adjustable feet. Also in one embodiment the second vertically adjustable feet comprise through holes for use with fasteners in attaching the feet to a surface. In another embodiment the second vertically adjustable feet comprise one or more of pads with rubber-like or fabric underlayers for protection of contacted surfaces, or metal pads with anti-slip features. Also the first vertically adjustable feet may have through holes for use with fasteners in attaching the feet to a surface.

In some embodiments the first vertically-adjustable feet comprise one or more of pads with rubber-like or fabric underlayers for protection of contacted surfaces or metal pads with anti-slip features. Also in some embodiments the vertically-adjustable base portion comprises one tubing slidably engaging another, and a friction mechanism for restraining the two tubings at a selected height. In still other embodiments the first engagement interface comprises a first length of angle iron having two sides disposed at a right angle at a joined edge, disposed with the joined edge facing upward, and the second engagement interface comprises a second length of angle iron arrayed in the orientation of the first, such that the second may engage the first forming an intimate contact and engagement.

In some embodiments the upper carrier element is a roller supported between two spaced apart end brackets on one or more shafts with bearings. In other embodiments the detachable roller assembly includes a user-operable brake for engaging the roller to prevent rotation. In still other embodiments the upper carrier element is a flat plate pivotable between two spaced-apart end brackets, and there may be a locking knob for securing the flat plate at a particular angle.

In another aspect of the invention a support module is provided, comprising end brackets supporting a roller, four adjustable feet, and an engagement interface for engaging a matching interface on an adjustable support stand.

In yet another aspect of the invention a support module is provided, comprising end brackets supporting a pivotable flat plate, four adjustable feet, and an engagement interface for engaging a matching interface on an adjustable support stand.

### BRIEF DESCRIPTION OF THE DRAWING FIGURES

FIG. 1 is a perspective view of a modular support stand according to an embodiment of the present invention.

FIG. 2 is an elevation view of the stand of FIG. 1 in use in an embodiment of the invention.

FIG. 3 is a magnified view of the stand of FIGS. 1 and 2 with an upper roller assembly separated from an upper frame component in an embodiment of the present invention.

FIG. 4 is a perspective view of the frame of the upper roller assembly shown proximate the upper frame assembly in an embodiment of the invention.

FIG. 5 is an elevation view of a supported chop saw used with a roller assembly according to an embodiment of the present invention.

FIG. 6 is a partial section through upper roller assembly 109 to show detail of a brake assembly in one embodiment of the invention.

FIG. 7a illustrates an embodiment of the invention comprising a unit the inventor terms a silent partner support.

FIG. 7b is a section view taken along line 7b-7b of FIG. 7a.

FIG. 8 illustrates yet another embodiment of the invention, useful for supporting utility elements.

### DESCRIPTION OF THE PREFERRED EMBODIMENTS

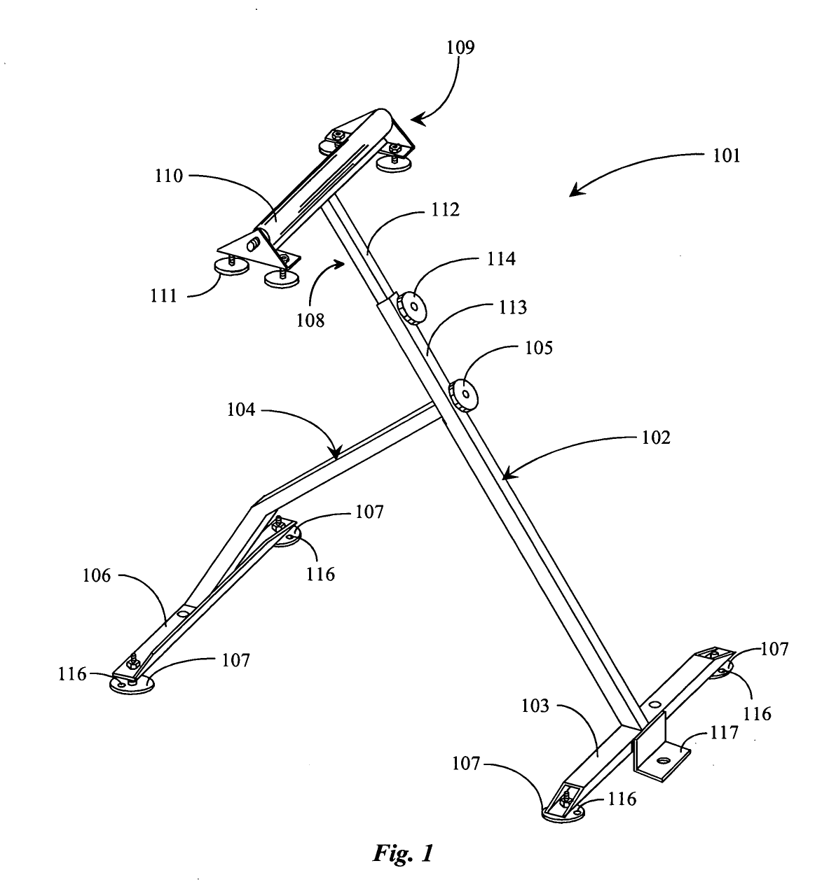

FIG. 1 is a perspective view of a modular support stand 101 according to an embodiment of the present invention. Stand 101 has a first lower frame component 102 consisting of a tubular portion 113 and a cross-piece 103 joined to tubular portion 113 by such as welding or brazing in this embodiment. Cross-piece 103 has adjustable support feet 107 for partially supporting the stand. A second lower frame component 104 joins as a separable entity to first frame component 102 by means of a hand knob 105 having a threaded post (not seen) that engages a nut (also not seen) within tubing of component 104. In preferred embodiments frame component 104 pivots in a hinged arrangement on component 102, such that components 102 and 104 may lie adjacent for transport and shipping, and component 104 may be extended to place the stand in operation, with component 104 secured in position by engaging and tightening knob 105.

Frame component 104 also has a cross-piece 106 with two adjustable support feet 107, one at each end as for cross-piece 103 of component 102. With component 104 assembled to component 102 a sturdy and stable base is formed having four adjustable feet (107) for supporting all of the other parts of the stand. Also in preferred embodiments feet 107 may have through holes 116 in one or more of feet 107 for attaching the feet to such as subflooring at a construction site, to maintain the stand in rigid position during use. In some embodiment the ability to attach to the subflooring may be provided at any two of the feet, and in some cases may be provided by another mechanism, such as a bracket 117 welded to cross piece 103 or crosspiece 106.

An upper frame component 108 comprises a square tubular portion 112 joined to an upper roller assembly 109 in a manner to be described below with aid of further figures. In an embodiment of the invention roller assembly 109 is modular and quickly and easily removable from upper frame 108. Tubular portion 112 is smaller than portion 113 of component 102 such that portion 112 may slide within portion 113 so the height of roller assembly 109 may be adjusted above the ground level upon which feet 107 reside. A knob 114 engages through a nut (not shown) welded to portion 113, such that a shaft may be brought to bear on portion 112 to fix the height once adjusted.

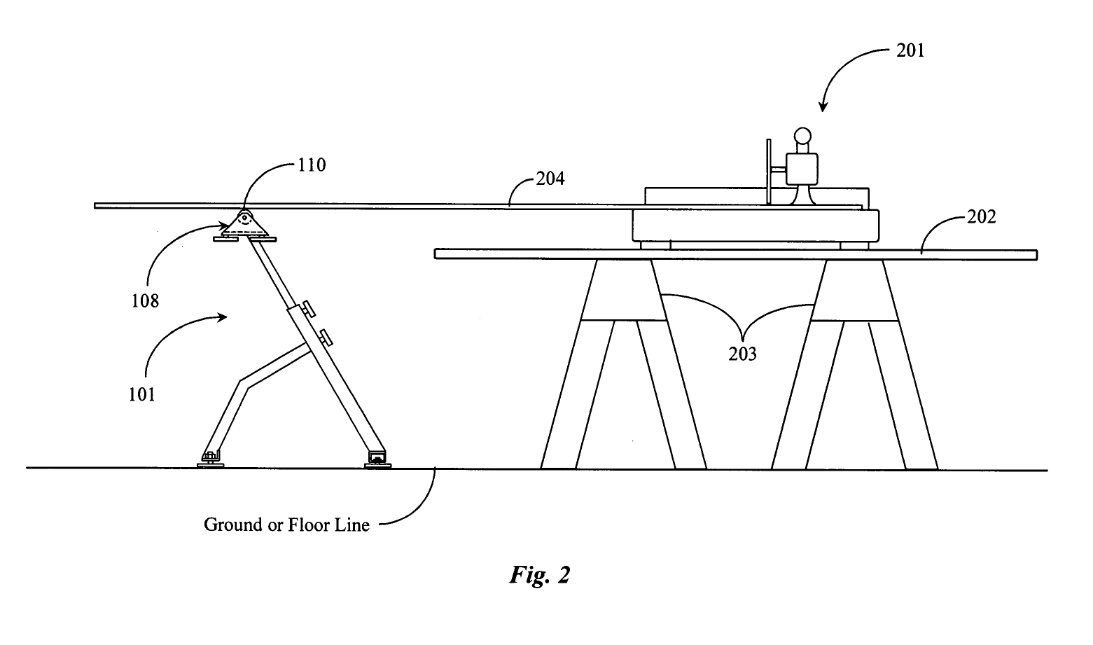

FIG. 2 is an elevation view of the stand of FIG. 1 in use in an embodiment of the invention. In this example chop saw 201 is supported on a piece of plywood 202 in turn supported on two saw horses 203 on a floor or ground surface. The skilled artisan will recognize that there are many models and varieties of such saws in the art, and the representation of chop saw 201 is meant to be exemplary and inclusive. The skilled artisan will also recognize that the chop saw may be supported on tables other than the piece of plywood on saw horses, but the arrangement shown is a typical mode of use on a job site where it is necessary to trim materials such as moldings for finish carpentry work.

Moldings of all types and of many different lengths may need to be beveled and trimmed on such a job site. Baseboard moldings, for example, may be quite long, or relatively short. Molding 204 represented in FIG. 2 is of a length sufficient that outboard support is needed to hold the molding level so trim cuts may be accurately, efficiently and safely made. For molding much longer additional supports may be needed as well.

It was briefly mentioned above that roller assembly 109 may be quickly and easily removed from upper frame 108 in an embodiment of the invention. In the arrangement shown it is not necessary to do so, and in fact such stands exit in the art wherein the roller assembly is an integral part of the overall stand assembly, and these prior art stands are commonly used for support of long pieces to be trimmed.

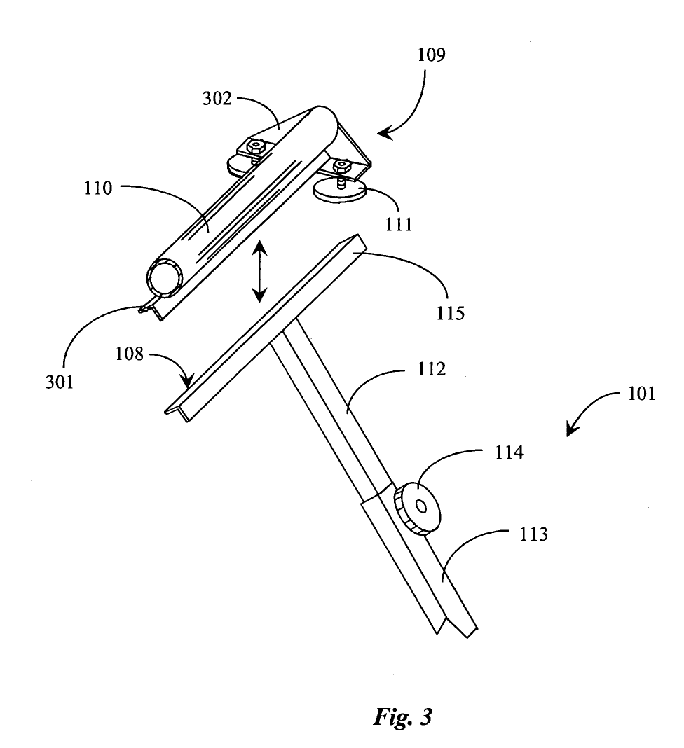

FIG. 3 is a magnified view of upper roller assembly 109 and an upper part of frame component 108 in which roller assembly 109 has been removed from frame component 108. Roller assembly 109 has been partially sectioned to illustrate additional detail of construction in this particular embodiment. In frame component 108 a short piece of angle iron 115 is welded to tubular portion 112 such that the apex of the angle of the angle iron is directed upward forming a triangle with a horizontal base. Framing of modular roller assembly 109 also comprises an angle iron 301 in the same orientation as angle iron 115 of upper frame 108, wherein angle iron 301 is welded between two end brackets 302. The end brackets 302 form spaced-apart vertical surfaces between which roller 110 is mounted on a shaft with bearings. The bearings can be of any one of several different types, such as roller bearings of journal bearings to provide for easy rotation of the roller. The upper roller assembly also comprises four adjustable feet 111 similar to adjustable feet 107 used on the lower support elements.

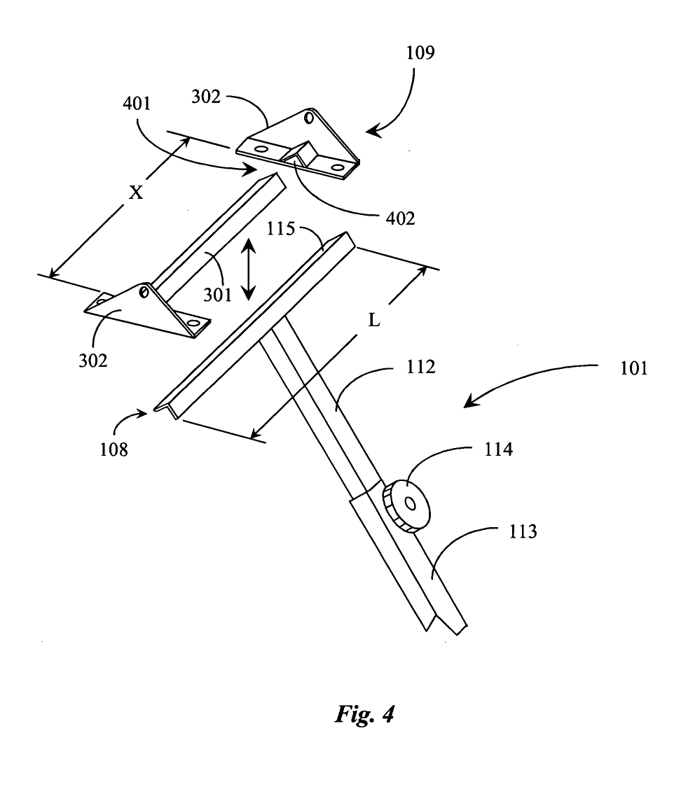

A portion of FIG. 4 is a perspective view of the frame of upper roller assembly 109, composed of angle iron 301 and the two end brackets 302, shown proximate the upper frame assembly 108 as in FIG. 3, but without roller 110 and adjustable feet 111. Angle iron 301 has been cut away to show a triangular opening 402 that is formed at each end by welding the angle iron to horizontal flange portions of end brackets 302. This opening in one embodiment of the invention is important to secure the upper roller assembly 109 to the upper frame assembly 108.

In this embodiment length L of angle iron 115 is somewhat greater than length X of angle iron 301. For example, if X is 8 inches, L may be 8.5 inches. So roller assembly 109 will not mate with frame assembly 108 by simple vertical placement. In this embodiment a portion of length L of angle iron 115 on each end is machined to fit easily into triangular openings 402 on each end of assembly 109. Joining of the two is accomplished by engaging one end of angle iron 115 in one of openings 402 far enough that angle iron 301 may intimately rest on angle iron 115. Then the roller assembly is moved so both ends of angle iron 115 engage openings 402 at each of the end brackets.

The skilled artisan will recognize that the joining arrangement described above is but one example of how the two assemblies may be easily and quickly joined, and may be expected to stay joined in use. There are a variety of other ways this joining may be accomplished, such as by plate-to-plate contact and securing with conventional fasteners, such as bolts and nuts.

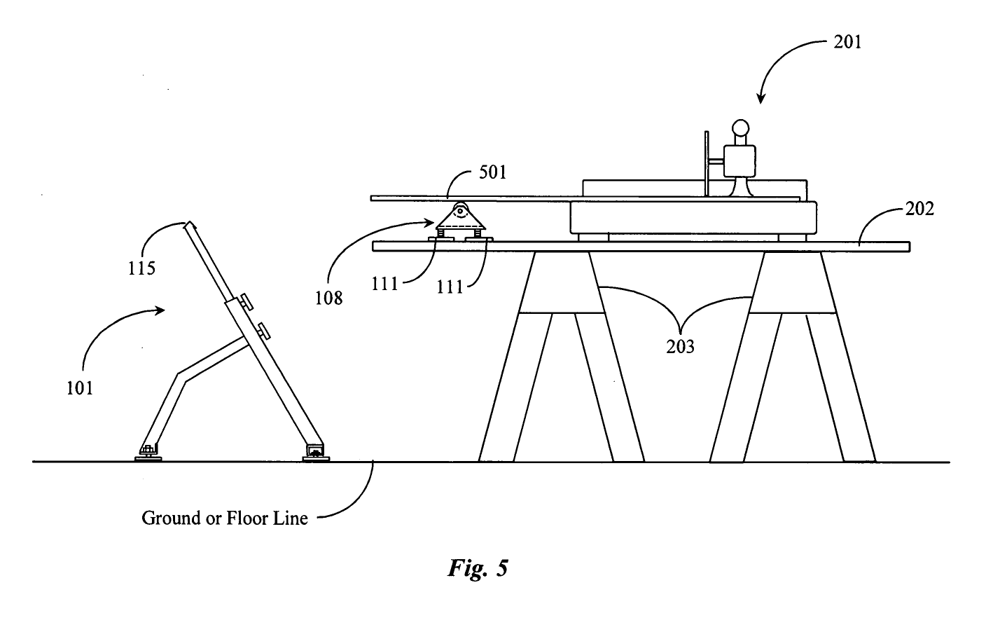

FIG. 5 is an elevation view of a supported chop saw being used with a relatively short piece of molding 501 to be cut. Molding 501 is too long to be cut reliably unsupported from table 202, but too short to be supported by the integrated roller stand 101 as shown in FIG. 2. In this case upper roller assembly 108 has been disengaged from stand 101 and placed on table 202 supported by feet 111, which have been pre-adjusted to provide the roller at the correct height, that is at the table height of chop saw 201. The idea in every case is that a molding or other piece to be cut should never be unsupported such that if the operator lets go, the molding will tip up on the chop saw table. For this use, there may be through holes in one or more of feet 11, just as described above for feet 107, so the upper roller assembly may be secured to the chop saw table by such as screws or other conventional fasteners.

Roller 110 in the roller assembly may be metal, or may be fabricated from a polymer material, such as a ultra-high-molecular-weight (UHMW) polymer. The bearings that carry the roller on a shaft or shafts supported by end brackets 302 of roller assembly 109 may be in some cases journal bearings, or may be ball bearings. Adjustable feet 111 may be mounted to be adjustable in any of several ways. The threaded post arrangement shown with nuts is but one example.

In one embodiment there may be an additional feature associated with upper roller assembly 109 to aid in a particular situation in operation. The particular situation is as follows: when one has a piece of material to be cut on a chop saw, with one end supported, as in either of FIG. 2 or FIG. 5, the purpose is always to provide a trimmed piece for a specific purpose; so one of the resulting two pieces is the trimmed piece, and the other is surplus, either to be discarded or reused. In some cases the finished piece will be that to the left side of the blade, and in some cases the finished piece will be that to the right side of the blade, depending on the angle and the nature of the cut to be made.

Experience has shown that it is best to hold the side that will result in the finished piece with one hand securely until the cut is finished. The other hand has to operate the chop saw carriage. If the finished piece is on the side with the support stand, there is no problem, because that side will be held with one hand. If the finished piece is on the right, however, then the piece on the left, with additional length supported by the roller stand or upper roller assembly on the chop saw table, then there is a potentially bad situation. If there is sufficient overhang, placing too much weight on the side of the support stand roller away from the chop saw table, then, at the point in time that the cut is finished the piece not held may tip up and roll away, striking the floor or some other object. This at the minimum can mean an extra cut to be made, or a piece not further usable.

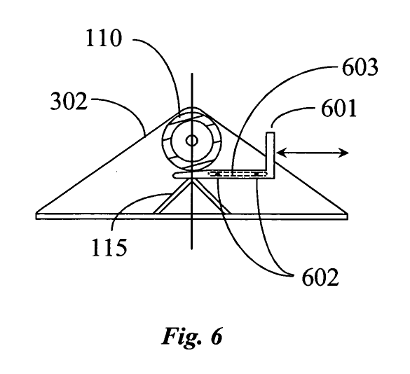

As an answer to this situation, in one embodiment a friction brake is provided to temporarily lock roller 10 from rolling. FIG. 6 is a partial section through upper roller assembly 109 to show some detail of one such friction brake. In this example a tapered lever 601 is supported on two pins 602 engaged in a slot 603 cut in end piece 302. The slot is provided in a position and of a length that a user may withdraw lever 601 along the slot so no engagement is made between roller 110 and the lever, which may be further supported by angle iron 115, or the user may move the lever to wedge between roller 110 and angle iron 115, to effectively prevent the roller from turning. The lever, at least at the surface where it will engage the roller, may be made of a plastic material or a flexible, rubber-like material to better wedge and lock the roller.

Now, in the particular situation described above, when there is a chance that a piece not securely held may tip up and roll away at the finish of a cut, the user may first lock the roller, providing ample time after a cut is finished to catch the piece that might otherwise get away.

Chop saws may be used inside houses under construction or in houses where remodeling is being done, or may be used out-of-doors as well. For this reason adjustable feet 111 for the roller assembly and 107 for the roller stand may be of several different types. In one case the pads may be metal with anti-slip features, such as pointed protrusions or corrugation, for use perhaps on dirt surfaces. In other cases the pads may have a rubber-like or a fabric (such as felt) pad on the undersurface to avoid damaging such as tile or hardwood floors where a stand may need to be used. In many cases there may be openings through the feet for fasteners, such as bolts or screws, for fastening to such as subflooring.

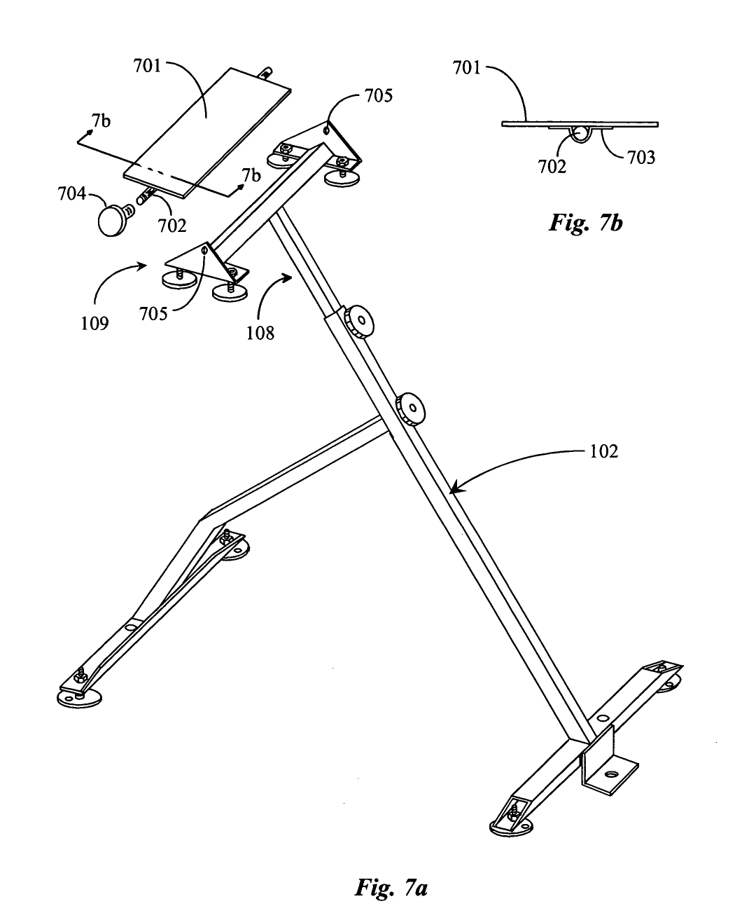

In still another embodiment of the present invention the lower frame (102 of FIG. 1) may be used as a support stand for a variety of purposes other than supporting an upper roller assembly. FIG. 7a illustrates an embodiment comprising a unit the inventor terms a silent partner support. In this embodiment upper assembly 109 has no roller, but instead a pivotable flat plate 701, made pivotable by a pivot shaft 702 fastened to the underside of plate 701. FIG. 7b is a section view of the plate and pivot shaft taken along line 7b-7b of FIG. 7a. As shown in FIG. 7b the shaft may be secured to the plate in a number of ways, such as by one or more brackets 703, by welding, or in other ways. The shaft may be one shaft greater in length than the plate, or there may be two shafts in axial alignment, one at either end of the plate.

At one or both ends shaft 702 has male threads, and a hand knob with a female thread may be used at one or both ends to secure plate 701 in the assembly so it does not rotate on the shaft. The purpose of the repositionable flat plate on the adjustable support stand is as a stationary aid for supporting material without movement during installation or production.

It is not intended that the plate and pivot shaft be easily removable from the assembly 109. Rather it is the entire assembly that is removable, so it may be used in this mode as a stationary support on the adjustable stand 102/108, or on a saw table or other surface, A skilled artisan will be aware that the plate may vary in width and that there are a number of other changes that might be made without departing from the spirit and scope of the invention.

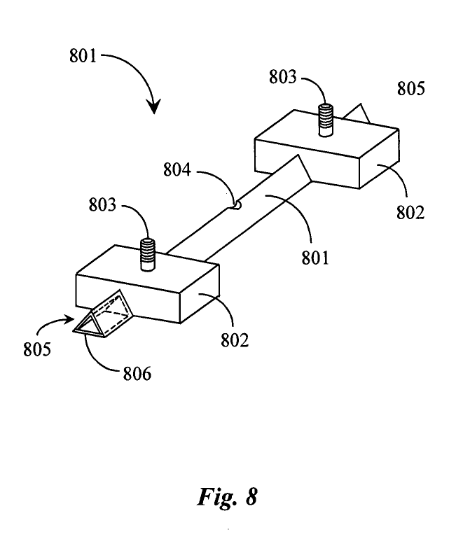

FIG. 8 illustrates an embodiment of the invention useful for supporting other useful elements and apparatus not thus far described. Apparatus 800 is based on a length of angle iron 801 synonymous with angle 301 of assembly 109 in FIG. 3. Angle 801 has a short piece of flat stock 806 welded to the bottom of the angle to create a pocket 805 at each end. It is pocket 805 that provides the necessary sockets for attaching assembly 800 to angle 115 of upper support assembly 108 (see FIG. 3). Angle 801 has through holes 804 strategically placed, and shaped bars 802 attached also at strategic locations. Bars 802 may be welded in place, or bolted, or fastened by some other conventional method. Bars 802 have threaded studs 803 attached for use in mounting other units to the stand. Many sorts of utility elements, such as florescent light fixtures, halogen fixtures and the like may be attached to assembly 800 in various embodiments.

The skilled artisan will be aware that many features of the integrated roller stand and utility stand described in enabling detail in various embodiments above may be altered from the examples illustrated and described in this disclosure, without departing from the spirit and scope of the invention. For example, there are a variety of ways the vertical adjustability of the integrated roller stand may be accomplished. There are also many different materials that may be used. In addition, the base support may be accomplished in different ways. There are similarly many other alterations that fall within the spirit and scope of the invention, which should be accorded the breadth of the claims to follow.

What is claimed is:

1. A two-part support stand, comprising:
a vertically-adjustable base portion having a multiple-point support structure for standing on a ground or floor plane, and a first upper engagement interface; and
a separate and detachable assembly having an upper carrier element, a second engagement interface for engaging the first engagement interface, and a plurality of first vertically adjustable feet;
wherein the separate detachable assembly, attached to the base portion may be used to support workpieces, or may be disengaged from the base portion and used, supported on its plurality of adjustable feet, as a stand-alone support for workpieces.

2. The support stand of claim 1 wherein the plural-point support structure comprises one or more second vertically-adjustable feet.

3. The support stand of claim 2 wherein the second vertically adjustable feet comprise through holes for use with fasteners in attaching the feet to a surface.

4. The support stand of claim 2 wherein the second vertically adjustable feet comprise one or more of pads with rubber-like or fabric underlayers for protection of contacted surfaces, or metal pads with anti-slip features.

5. The support stand of claim 1 wherein the first vertically adjustable feet comprise through holes for use with fasteners in attaching the feet to a surface.

6. The roller support stand of claim 1 wherein the first vertically-adjustable feet comprise one or more of pads with rubber-like or fabric underlayers for protection of contacted surfaces or metal pads with anti-slip features.

7. The support stand of claim 1 wherein the vertically-adjustable base portion comprises one tubing slidably engaging another, and a friction mechanism for restraining the two tubings at a selected height.

8. The support stand of claim 1 wherein the first engagement interface comprises a first length of angle iron having two sides disposed at a right angle at a joined edge, disposed with the joined edge facing upward, and the second engagement interface comprises a second length of angle iron arrayed in the orientation of the first, such that the second may engage the first forming an intimate contact and engagement.

9. The support stand of claim 1 wherein the upper carrier element is a roller supported between two spaced apart end brackets on one or more shafts with bearings.

10. The support stand of claim 9 wherein the detachable roller assembly includes a user-operable brake for engaging the roller to prevent rotation.

11. The support stand of claim 1 wherein the upper carrier element is a flat plate pivotable between two spaced-apart end brackets.

12. The support stand of claim 11 comprising a locking knob for securing the flat plate at a particular angle.

13. A support module comprising:
end brackets supporting a roller;
four adjustable feet; and
an engagement interface for engaging a matching interface on an adjustable support stand.

14. A support module comprising:
end brackets supporting a pivotable flat plate;
four adjustable feet; and
an engagement interface for engaging a matching interface on an adjustable support stand.
